(19) United States
(12) Patent Application Publication
(10) Pub. No.: US 2025/0372081 A1
(43) Pub. Date: Dec. 4, 2025

(54) PERSONALIZED NEARBY VOICE DETECTION SYSTEM

(71) Applicant: BOSE CORPORATION, Framingham, MA (US)

(72) Inventors: Chuan-Che HUANG, Natick, MA (US); Shuo ZHANG, Belmont, MA (US)

(21) Appl. No.: 18/678,925

(22) Filed: May 30, 2024

(51) Int. Cl. G10L 15/08; G10L 13/02; G10L 15/22

(52) U.S. Cl. CPC G10L 15/08; G10L 13/02; G10L 15/22; G10L 2015/088

(57) ABSTRACT

Aspects of the present disclosure provide techniques, including devices and systems implementing the techniques, to enabling a wearable device to identify one or more words or phrases selected by a user to facilitate user awareness and interaction. One example technique comprises prompting a user to input one or more words or phrases related to how others refer to the user, generating, using the input, data to detect the one or more words or phrases, and determining, using the data, that sound detected in an environment passes a threshold of including the one or more words or phrases. In aspects, the data is generated in a vector system. When a nearby voice or noise is identified by the wearable device, the voice or noise may then be compared to the data in the vector system to determine whether the voice or noise is the user’s selected words or phrases.

### FIELD

Aspects of the disclosure generally relate to systems and wearable devices, and, more particularly, to techniques to enable a wearable device to identify one or more words or phrases related to how others refer to a user.

### BACKGROUND

Wearable audio output devices may provide a user with a desired transmitted or reproduced audio experience by masking, proofing against, or canceling ambient noises. For example, high volume output or white noises generated by the wearable devices may mask ambient noises. Soundproofing in the wearable audio output devices may also reduce sound pressure by reflecting or absorbing sound energy. In addition, noise cancellation (e.g., active noise cancelling (ANC)), or active noise control/reduction, may reduce ambient noises by the addition of a second sound that cancels the ambient noises to provide an immersive audio experience to the user. In these cases, the user may be effectively isolated from ambient noise, and may not become aware of events occurring in the vicinity of the user, such as when someone calls the user’s name. As a result, the user may be unaware of events that are important to the user.

Accordingly, methods for facilitating user awareness and interaction using wearable audio output devices, as well as apparatuses and systems configured to implement these methods, are desired.

### SUMMARY

All examples and features mentioned herein can be combined in any technically possible manner.

Aspects of the present disclosure provide a method for identifying one or more words or phrases related to how others refer to a user in a wearable device. The method includes prompting a user to input one or more words or phrases related to how others refer to the user; generating, using the input, data to detect the one or more words or phrases from a variety of sounds of speech input; and determining, using the data, that sound detected in an environment passes a threshold of including the one or more words or phrases.

In aspects, the method further comprises comparing the data to reference data.

In aspects, the reference data comprises a plurality of reference audio samples that include the one or more words or phrases.

In aspects, the reference data is pre-obtained by a plurality of non-users.

In aspects, the reference data comprises negative data that fails to include the one or more words or phrases.

In aspects, the data is plotted against the reference data in a vector space to determine how closely the data matches the reference data versus the negative data.

In aspects, the threshold is a distance measured within the vector space that the sound detected in the environment includes the one or more words or phrases based on the plotted data.

In aspects, the method further comprises performing an action in response to the determination that the sound detected passes the threshold.

In aspects, the input is text.

In aspects, the input is audio.

Aspects of the present disclosure provide a system. The system includes a device comprising: an interface; and at least one first processor configured to prompt a user to input one or more words or phrases related to how others refer to the user into the interface; and a wearable audio device in communication with the device, the wearable audio device comprising: at least one audio sensor; and at least one second processor configured to: generate, using the input, data to detect the one or more words or phrases from a variety of sounds of speech input; and determine, using the data, that sound detected in an environment passes a threshold of including the one or more words or phrases.

In aspects, the at least one first processor is further configured to synthesize multiple different audio samples that include the one or more words or phrases prior to the data being generated by the at least one second processor.

In aspects, the at least one second processor is further configured to compare the data to reference data.

In aspects, the reference data comprises a plurality of reference audio samples that include the one or more words or phrases.

In aspects, the reference data is pre-obtained by a plurality of non-users.

In aspects, the reference data comprises negative data that fails to include the one or more words or phrases.

In aspects, the data is plotted against the reference data in a vector space to determine how closely the data matches the reference data versus the negative data.

In aspects, the threshold is a distance measured within the vector space that the sound detected in the environment includes the one or more words or phrases based on the plotted data.

In aspects, the at least one second processor is further configured to perform an action in response to the determination that the sound detected passes the threshold.

In aspects, the input is text or audio.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2A illustrates an exemplary wireless audio device, in which aspects of the present disclosure may be implemented.

FIG. 2B illustrates an exemplary computing device, in which aspects of the present disclosure may be implemented.

FIG. 3A illustrates example operations performed by a system in communication with a wearable device worn by a user for managing ambient noise, according to certain aspects of the present disclosure.

FIG. 3B illustrates example operations performed by a wearable device worn by a user for managing ambient noise, according to certain aspects of the present disclosure.

FIG. 4A illustrates an exemplary vector space that is utilized during the operations of FIGS. 3A-3B, according to certain aspects of the present disclosure.

FIG. 4B illustrates an exemplary vector space that is utilized during the operations of FIGS. 3A-3B, according to certain aspects of the present disclosure.

Like numerals indicate like elements.

### DETAILED DESCRIPTION

Certain aspects of the present disclosure provide techniques, including devices and system implementing the techniques, for enabling a wearable device to identify one or more words or phrases related to how others refer to a user to facilitate user awareness and interaction. The identification process utilizes one or more vector spaces to compare a user’s preferred attention-grabbing name (i.e., one or more words or phrases selected by the user) to mitigate the impact of unimportant events on a user’s audio experience while facilitating user awareness of important events, thus enabling the user to interact with the important events as desired.

Wearable audio output devices help users enjoy high quality audio and participate in productive voice calls. However, users often lose at least some situational awareness when using wearable audio output devices. In some cases, situational awareness is decreased when the volume of the audio is at an excessive level that masks over ambient sound, or the devices have good soundproofing (e.g., passive sound insulation). In addition, wearable audio output devices with noise cancellation also reduce situational awareness by attenuating sounds, including noise external to the audio output devices. Situational awareness may also be decreased when the user is in a focused state, such as when working, studying, or reading, with the aid of the wearable audio device (e.g., canceling or attenuating ambient sound). In other words, wearable audio output devices (especially those utilizing noise cancellation) tend to isolate the user from the surrounding world, making it difficult for the user to be aware of important events occurring around them, such as when someone is trying to talk to the user. In some cases, the user may want to quickly adjust the wearable device’s audio level (e.g., by lowering noise cancellation and audio volume) to respond to an important event, such as another person speaking to them, and enable a conversation with that nearby person. However, it is often cumbersome for users to control or doff their earbuds or headphones to respond to the event.

One possible solution to manage the ambient noise and facilitate user awareness and interaction is to embed sound event detection algorithms in the wearable device, so that the user may turn off noise cancellation or pause audio content when an important event is detected (e.g., self-voice or a nearby sound event). However, it may be difficult for a wearable device to differentiate between different sounds with similar characteristics, such as differentiating between an event when someone is merely chatting nearby and when someone is attempting to talk to the user. Similarly, it may be difficult for a wearable device to determine if a sound event comes from nearby entertainment (e.g., television, music, a podcast, etc.), which may not be important to the user, or from someone talking to you (e.g., a family member), which may be important to the user. As a result of not being able to distinguish between when an event that is important to the user has been detected and when an event that is not important to the user has been detected, the wearable device may not take appropriate actions in response to the detected event. For example, the wearable device may greatly decrease the audio volume of the wearable device output, or even pause the audio output in response to a detected event that is not important to the user (e.g., co- workers conversing with each other), greatly disrupting the user’s audio experience. In another example, the wearable device may output a notification sound (e.g., a tone) in response to a detected event that is not important to the user, which may also disrupt the user’s audio experience. The present disclosure may enable the wearable device of a user to minimize the undesirable consequences of detecting an event and negatively impacting the user’s audio experience when an unimportant event is detected, while enabling the wearable device to take appropriate and sufficient action to allow the user to be aware of important events. As a result, the user may be able to continue to enjoy their audio experience with minimal interruption when unimportant events are detected, and be alerted or otherwise made aware of important events as desired.

### An Example System

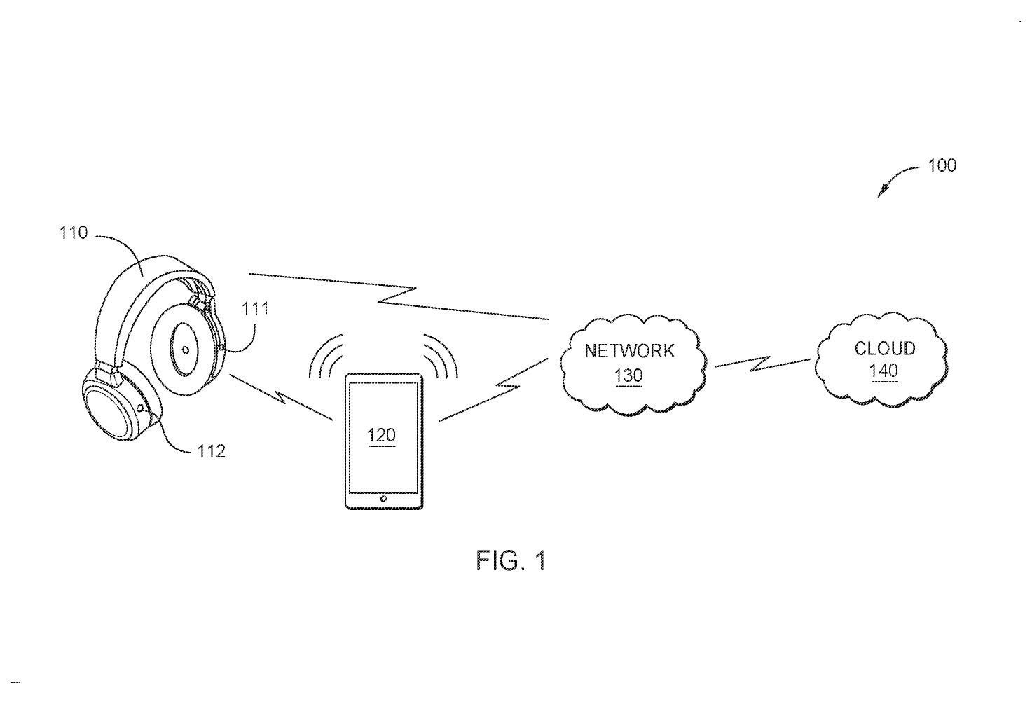

FIG. 1 illustrates an example system 100, in which aspects of the present disclosure are practiced. As shown, system 100 includes a wearable device 110 communicatively coupled with a computing device 120. The wearable device 110 may be configured to be worn by a user, and may be a headset that includes two or more speakers and two or more microphones, as illustrated in FIG. 1. The computing device 120 is illustrated as a smartphone or a tablet computer wirelessly paired with the wearable device 110. At a high level, the wearable device 110 may play audio content transmitted from the computing device 120. The user may use the graphical user interface (GUI) on the computing device 120 to select the audio content and/or adjust settings of the wearable device 110. The wearable device 110 provides soundproofing, active noise cancellation, and/or other audio enhancement features to play the audio content transmitted from the computing device 120. According to aspects of the present disclosure, upon the determining of an event (e.g., measuring a sound and/or detecting an action), the wearable device 110 and/or the computing device 120 may facilitate the awareness of the user by taking one or more actions. The one or more actions may include, for example, decreasing an audio volume of the wearable device 110, decreasing a noise cancellation of the wearable device 110, increasing a transparency of the wearable device 110, pausing an audio output of the wearable device 110, or outputting a notification sound from the wearable device 110.

In certain aspects, the wearable device 110 includes at least two microphones 111 and 112 to capture ambient sound. The captured sound may be used for active noise cancellation and/or event detection. For example, the microphones 111 and 112 may be positioned on opposite sides of the wearable device 110, as illustrated.

In certain aspects, the wearable device 110 includes voice activity detection (VAD) circuitry capable of detecting the presence of speech signals (e.g., human speech signals) in a sound signal received by the microphones 111, 112 of the wearable device 110. For instance, the microphones 111, 112 of the wearable device 110 can receive ambient and external sounds in the vicinity of the wearable device 110, including speech uttered by the user. The sound signal received by the microphones 111, 112 may have the speech signal mixed in with other sounds in the vicinity of the wearable device 110. Using the VAD, the wearable device 110 may detect and extract the speech signal from the received sound signal. In certain aspects, the VAD circuitry may be used to detect and extract speech uttered by the user in order to facilitate a voice call, voice chat between the user and another person, or voice commands for a virtual personal assistant (VPA), such as a cloud based VPA. In some cases, detections or triggers can include self-VAD (only starting up when the user is speaking, regardless of whether others in the area are speaking), active transport (sounds captured from transportation systems), head gestures, buttons, computing device based triggers (e.g., pause/un-pause from the phone), changes with input audio level, and/or audible changes in environment, among others. The voice activity detection circuitry may run or assist running the activity detection algorithm disclosed herein.

In certain aspects, the wearable device 110 includes speaker identification circuitry capable of detecting an identity of a speaker to which a detected speech signal relates to. For example, the speaker identification circuitry may analyze one or more characteristics of a speech signal detected by the VAD circuitry and determine that the user of the wearable device 110 is the speaker. In certain aspects, the speaker identification circuitry may use any of the existing speaker recognition methods and related systems to perform the speaker recognition.

The wearable device 110 further includes hardware and circuitry including processor(s)/processing system and memory configured to implement one or more sound management capabilities or other capabilities including, but not limited to, noise canceling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the wearable device 110 by using active noise cancelling (also known as active noise reduction). The sound masking circuitry is configured to reduce distractions by playing masking sounds via the speakers of the wearable device 110. The movement detecting circuitry is configured to use devices/sensors such as an accelerometer, gyroscope, magnetometer, or the like to detect whether the user wearing the wearable device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In an aspect, the wearable device 110 is wirelessly connected to the computing device 120 using one or more wireless communication methods including, but not limited to, Bluetooth, Wi-Fi, Bluetooth Low Energy (BLE), other radio frequency (RF) based techniques, or the like. In certain aspects, the wearable device 110 includes a transceiver that transmits and receives data via one or more antennae in order to exchange audio data and other information with the computing device 120.

In an aspect, the wearable device 110 includes communication circuitry capable of transmitting and receiving audio data and other information from the computing device 120. The wearable device 110 also includes an incoming audio buffer, such as a render buffer, that buffers at least a portion of an incoming audio signal (e.g., audio packets) in order to allow time for retransmissions of any missed or dropped data packets from the computing device 120. For example, when the wearable device 110 receives Bluetooth transmissions from the computing device 120, the communication circuitry typically buffers at least a portion of the incoming audio data in the render buffer before the audio is actually rendered and output as audio to at least one of the transducers (e.g., audio speakers) of the wearable device 110. This is done to ensure that even if there are RF collisions that cause audio packets to be lost during transmission, there is time for the lost audio packets to be retransmitted by the computing device 120 before the lost audio packets have been rendered by the wearable device 110 for output by one or more acoustic transducers of the wearable device 110.

The wearable device 110 is illustrated as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, or eyeglasses.

In certain aspects, the wearable device 110 is connected to the computing device 120 using a wired connection, with or without a corresponding wireless connection. The computing device 120 may be a smartphone, a tablet computer, a laptop computer, a digital camera, or other computing device that connects with the wearable device 110. As shown, the computing device 120 can be connected to a network 130 (e.g., the Internet) and may access one or more services over the network. As shown, these services can include one or more cloud services 140.

In certain aspects, the computing device 120 can access a cloud server in the cloud 140 over the network 130 using a mobile web browser or a local software application or “app” executed on the computing device 120. In certain aspects, the software application or “app” is a local application that is installed and runs locally on the computing device 120. In certain aspects, a cloud server accessible on the cloud 140 includes one or more cloud applications that are run on the cloud server. The cloud application may be accessed and run by the computing device 120. For example, the cloud application can generate web pages that are rendered by the mobile web browser on the computing device 120. In certain aspects, a mobile software application installed on the computing device 120 or a cloud application installed on a cloud server, individually or in combination, may be used to implement the techniques for low latency Bluetooth communication between the computing device 120 and the wearable device 110 in accordance with aspects of the present disclosure. In certain aspects, examples of the local software application and the cloud application include a gaming application, an audio AR or VR application, and/or a gaming application with audio AR or VR capabilities. The computing device 120 may receive signals (e.g., data and controls) from the wearable device 110 and send signals to the wearable device 110.

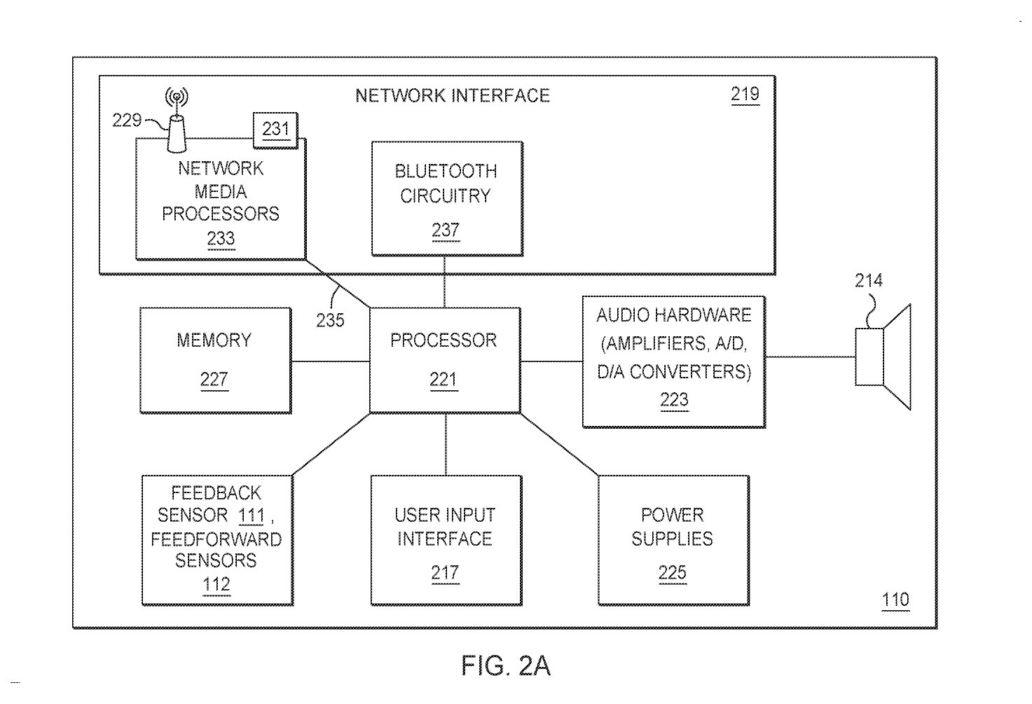

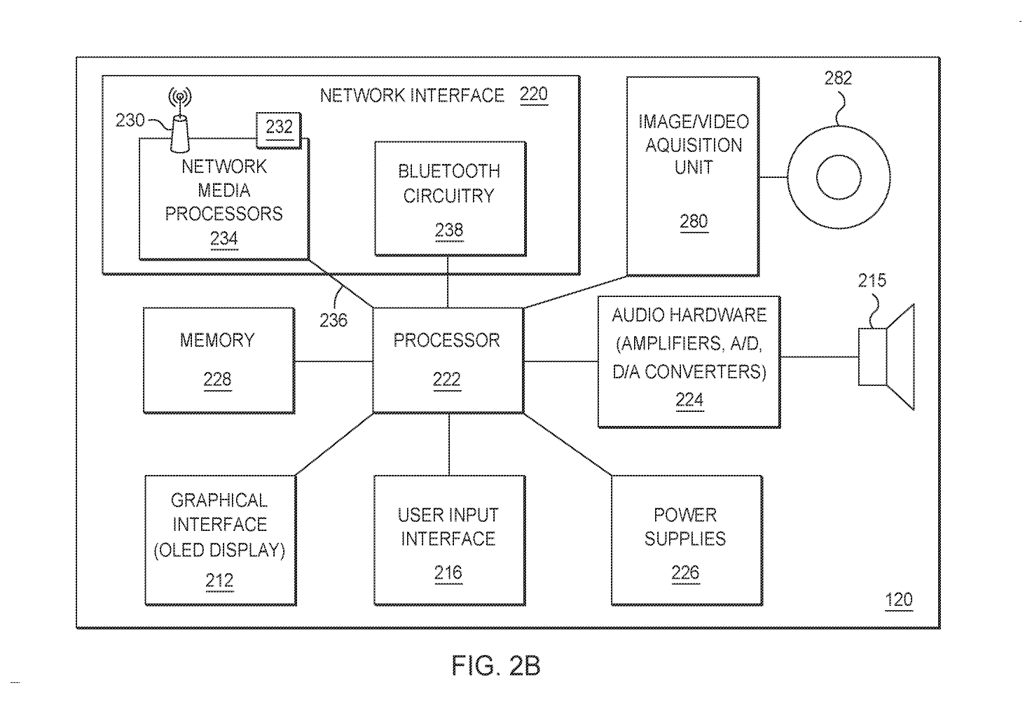

FIG. 2A illustrates an exemplary wearable device 110 and some of its components. Other components may be inherent in the wearable device 110 and not shown in FIG. 2A. For example, the wearable device 110 may include an enclosure that houses an optional graphical interface (e.g., an OLED display) which can provide the user with information regarding currently playing (“Now Playing”) music.

The wearable device 110 includes one or more electro-acoustic transducers (or speakers) 214 for outputting audio. The wearable device 110 also includes a user input interface 217. The user input interface 217 may include a plurality of preset indicators, which may be hardware buttons. The preset indicators may provide the user with easy, one press access to entities assigned to those buttons. The assigned entities may be associated with different ones of the digital audio sources such that a single wearable device 110 may provide for single press access to various different digital audio sources.

The wearable device 110 may include a feedback sensor 111 and feedforward sensors 112. The feedback sensor 111 and feedforward sensors 112 may include two or more microphones (e.g., microphones 111, 112 as illustrated in FIG. 1) for capturing ambient sound and provide audio signals for determining location attributes of events. For example, the feedback sensor 111 may provide a mechanism for determining transmission delays between the computing device 120 and the wearable device 110. The transmission delays may be used to reduce errors in subsequent computation. The feedback sensor 111 may provide two or more channels of audio signals. The audio signals are captured by microphones that are spaced apart and may have different directional responses. The two or more channels of audio signals may be used for calculating directional attributes of an event of interest.

As shown in FIG. 2A, the wearable device 110 includes an acoustic driver or speaker 214 to transduce audio signals to acoustic energy through audio hardware 223. The wearable device 110 also includes a network interface 219, at least one processor 221, the audio hardware 223, power supplies 225 for powering the various components of the wearable device 110, and memory 227. In certain aspects, the processor 221, the network interface 219, the audio hardware 223, the power supplies 225, and the memory 227 are interconnected using various buses 235, and several of the components can be mounted on a common motherboard or in other manners as appropriate.

The network interface 219 provides for communication between the wearable device 110 and other electronic computing devices via one or more communications protocols. The network interface 219 provides either or both of a wireless network interface 229 and a wired interface 231. The wireless interface 229 allows the wearable device 110 to communicate wirelessly with other devices in accordance with a wireless communication protocol such as IEEE 802.11. The wired interface 231 provides network interface functions via a wired (e.g., Ethernet) connection for reliability and fast transfer rate, for example, used when the wearable device 110 is not worn by a user. Although illustrated, the wired interface 231 is optional.

In certain aspects, the network interface 219 includes a network media processor 233 for supporting Apple AirPlay^{®} and/or Apple Airplay^{®}2. For example, if a user connects an AirPlay^{®} or Apple Airplay^{®}2 enabled device, such as an iPhone or iPad device, to the network, the user can then stream music to the network connected audio playback devices via Apple AirPlay^{®} or Apple Airplay^{®}2. Notably, the audio playback device can support audio-streaming via AirPlay^{®}, Apple Airplay^{®}2 and/or Digital Living Network Alliance’s (DLNA) Universal Plug and Play (UPnP) protocols, all integrated within one device.

All other digital audio received as part of network packets may pass straight from the network media processor 233 through a USB bridge (not shown) to the processor 221 and runs into the decoders, DSP, and eventually is played back (rendered) via the electro-acoustic transducer(s) 214.

The network interface 219 can further include Bluetooth circuitry 237 for Bluetooth applications (e.g., for wireless communication with a Bluetooth enabled audio source such as a smartphone or tablet) or other Bluetooth enabled speaker packages. In some aspects, the Bluetooth circuitry 237 may be the primary network interface 219 due to energy constraints. For example, the network interface 219 may use the Bluetooth circuitry 237 solely for mobile applications when the wearable device 110 adopts any wearable form. For example, BLE technologies may be used in the wearable device 110 to extend battery life, reduce package weight, and provide high quality performance without other backup or alternative network interfaces.

In certain aspects, the network interface 219 supports communication with other devices using multiple communication protocols simultaneously at one time. For instance, the wearable device 110 can support Wi-Fi/Bluetooth coexistence and can support simultaneous communication using both Wi-Fi and Bluetooth protocols at one time. For example, the wearable device 110 can receive an audio stream from a smart phone using Bluetooth and can further simultaneously redistribute the audio stream to one or more other devices over Wi-Fi. In certain aspects, the network interface 219 may include only one RF chain capable of communicating using only one communication method (e.g., Wi-Fi or Bluetooth) at one time. In this context, the network interface 219 may simultaneously support Wi-Fi and Bluetooth communications by time sharing the single RF chain between Wi-Fi and Bluetooth, for example, according to a time division multiplexing (TDM) pattern.

Streamed data may pass from the network interface 219 to the processor 221. The processor 221 may execute instructions (e.g., for performing, among other things, digital signal processing, decoding, and equalization functions), including instructions stored in the memory 227. The processor 221 may be implemented as a chipset of chips that includes separate and multiple analog and digital processors. The processor 221 may provide, for example, for coordination of other components of the audio wearable device 110, such as control of user interfaces.

In certain aspects, the protocols stored in the memory 227 may include BLE according to, for example, the Bluetooth Core Specification Version 5.2 (BT5.2). The wearable device 110 and the various components therein are provided herein to sufficiently comply with or perform aspects of the protocols and the associated specifications. For example, BT5.2 includes enhanced attribute protocol (EATT) that supports concurrent transactions. A new L2CAP mode is defined to support EATT. As such, the wearable device 110 includes hardware and software components sufficiently to support the specifications and modes of operations of BT5.2, even if not expressly illustrated or discussed in this disclosure. For example, the wearable device 110 may utilize LE Isochronous Channels specified in BT5.2.

The processor 221 provides a processed digital audio signal to the audio hardware 223 which includes one or more digital-to-analog (D/A) converters for converting the digital audio signal to an analog audio signal. The audio hardware 223 also includes one or more amplifiers which provide amplified analog audio signals to the electro-acoustic transducer(s) 214 for sound output. In addition, the audio hardware 223 may include circuitry for processing analog input signals to provide digital audio signals for sharing with other devices, for example, other speaker packages for synchronized output of the digital audio.

The memory 227 can include, for example, flash memory and/or non-volatile random access memory (NVRAM). In some aspects, instructions (e.g., software) are stored in an information carrier. The instructions, when executed by one or more processing devices (e.g., the processor 221), perform one or more processes, such as those described elsewhere herein. The instructions can also be stored by one or more storage devices, such as one or more computer or machine-readable mediums (for example, the memory 227, or memory on the processor). The instructions can include instructions for performing decoding (i.e., the software modules include the audio codecs for decoding the digital audio streams), as well as digital signal processing and equalization. In certain aspects, the memory 227 and the processor 221 may collaborate in data acquisition and real time processing with the feedback microphone 111 and feedforward microphones 112.

FIG. 2B illustrates an exemplary computing device 120, such as a smartphone or a mobile computing device, in accordance with certain aspects of the present disclosure. Some components of the computing device 120 may be inherent and not shown in FIG. 2B. For example, the computing device 120 may include an enclosure. The enclosure may house an optional graphical interface 212 (e.g., an organic light-emitting diode (OLED) display), as shown. The graphical interface 212 provides the user with information regarding currently playing (“Now Playing”) music or video. The computing device 120 includes one or more electro-acoustic transducers 215 for outputting audio. The computing device 120 may also include a user input interface 216 that enables user input.

The computing device 120 also includes a network interface 220, at least one processor 222, audio hardware 224, power supplies 226 for powering the various components of the computing device 120, and a memory 228. In certain aspects, the processor 222, the graphical interface 212, the network interface 220, the audio hardware 224, the one or more power supplies 226, and the memory 228 are interconnected using various buses 236, and several of the components can be mounted on a common motherboard or in other manners as appropriate. In some aspects, the processor 222 of the computing device 120 is more powerful in terms of computation capacity than the processor 221 of the wearable device 110. Such difference may be due to constraints of weight, power supplies, and other requirements. Similarly, the power supplies 226 of the computing device 120 may be of a greater capacity and heavier than the power supplies 225 of the wearable device 110.

The network interface 220 provides for communication between the computing device 120 and the wearable device 110, as well as other audio sources and other wireless speaker packages including one or more networked wireless speaker packages and other audio playback devices via one or more communications protocols. The network interface 220 can provide either or both of a wireless interface 230 and a wired interface 232. The wireless interface 230 allows the computing device 120 to communicate wirelessly with other devices in accordance with a wireless communication protocol, such as IEEE 802.11. The wired interface 232 provides network interface functions via a wired (e.g., Ethernet) connection.

In certain aspects, the network interface 220 may also include a network media processor 234 and Bluetooth circuity 238, similar to the network media processor 233 and Bluetooth circuity 237 in the wearable device 110 in FIG. 2A. Further, in aspects, the network interface 220 supports communication with other devices using multiple communication protocols simultaneously at one time, as described with respect to the network interface 219 in FIG. 2A.

All other digital audio received as part of network packets comes straight from the network media processor 234 through a bus 236 (e.g., universal serial bus (USB) bridge) to the processor 222 and runs into the decoders, DSP, and eventually is played back (rendered) via the electro-acoustic transducer(s) 215.

The computing device 120 may also include an image or video acquisition unit 280 for capturing image or video data. For example, the image or video acquisition unit 280 may be connected to one or more cameras 282 and capable of capturing still or motion images. The image or video acquisition unit 280 may operate at various resolutions or frame rates according to a user selection. For example, the image or video acquisition unit 280 may capture 4K videos (e.g., a resolution of 3840 by 2160 pixels) with the one or more cameras 282 at 30 frames per second, FHD videos (e.g., a resolution of 1920 by 1080 pixels) at 60 frames per second, or a slow motion video at a lower resolution, depending on hardware capabilities of the one or more cameras 282 and the user input. The one or more cameras 282 may include two or more individual camera units having respective lenses of different properties, such as focal length resulting in different fields of views. The image or video acquisition unit 280 may switch between the two or more individual camera units of the cameras 282 during a continuous recording.

Captured audio or audio recordings, such as the voice recording captured at the wearable device 110, may pass from the network interface 220 to the processor 222. The processor 222 executes instructions within the wireless speaker package (e.g., for performing, among other things, digital signal processing, decoding, and equalization functions), including instructions stored in the memory 228. The processor 222 can be implemented as a chipset of chips that includes separate and multiple analog and digital processors. The processor 222 can provide, for example, for coordination of other components of the audio computing device 120, such as control of user interfaces and applications. The processor 222 provides a processed digital audio signal to the audio hardware 224 similar to the respective operation by the processor 221 described in FIG. 2A.

The memory 228 can include, for example, flash memory and/or non-volatile random access memory (NVRAM). In certain aspects, instructions (e.g., software) are stored in an information carrier. The instructions, when executed by one or more processing devices (e.g., the processor 222), perform one or more processes, such as those described herein. The instructions can also be stored by one or more storage devices, such as one or more computer or machine-readable mediums (for example, the memory 228, or memory on the processor 222). The instructions can include instructions for performing decoding (i.e., the software modules include the audio codecs for decoding the digital audio streams), as well as digital signal processing and equalization.

Example Operations for Personalized Nearby Voice Detection

Aspects of the present disclosure provide techniques, including devices and system implementing the techniques, for providing ambient noise management in a wearable device to facilitate user awareness and interaction. The present disclosure may enable the user’s wearable device to minimize the undesirable consequences of detecting an event and negatively impacting the user’s audio experience when the event is unimportant, while enabling the wearable device to take appropriate action to allow the user to respond when the event is important.

In certain aspects, a wearable device may use multi-stage ducking (e.g., multiple stages of audio level adjustment) to manage ambient noise. In some cases, the ambient sound detected may be a voice event. In these cases, the wearable device may determine when the voice event is the voice of a nearby person (e.g., far-field voice), or when the voice belongs to the user (e.g., self- voice). For example, when the wearable device determines that a nearby person is talking to a user using the wearable device employing noise isolation techniques, the wearable device may duck the audio level (e.g., ramp down the audio volume mildly and adjust noise cancellation), to enable the user to be aware of their environment, so that the user may determine if they want to engage in a conversation. When the user decides to engage with the voice event, and begins speaking, the wearable device may duck the audio level again (e.g., ramp down the audio volume more deeply and further adjust noise cancellation), to enable the user to more fully hear themselves and the nearby voice, to permit the user and nearby person to have a smooth conversation. The wearable device may further determine when the conversation has ended (e.g., detect whether there is any more talking happening) using both self-voice and far-field voice detection, and may automatically return the audio level to the previous audio level (e.g., the audio volume and noise cancellation setting before the device ducked the audio level). This multi-stage ducking approach may help mitigate the determination of false positives, such as when people are talking near the user, but are not talking directly at or with the user. Because the wearable device may only slightly duck the audio level (e.g., mildly decreasing the audio volume level and slightly reducing noise cancellation), the interruption resulting from events that may not be of interest to the user (e.g., unimportant events) is less intrusive. However, the slight duck in the audio level may be sufficient to increase the awareness of the user enough so that the user may be aware of important events, and able to respond.

In some cases, the wearable device may detect a voice event, and determine that the voice event detected by the wearable device is the voice of the user (e.g., self-voice). In these cases, the wearable device may duck the audio level (e.g., ramp down the audio volume mildly and adjust noise cancellation) to enable the user to be aware of their environment, so that the user may determine if nearby people are responding to the user, as well as to enhance the user’s awareness of their environment generally. When the wearable device determines a nearby person is talking (e.g., far-field voice) in response to the user with the wearable device employing noise isolation techniques, the wearable device may duck the audio level again (e.g., ramp down the audio volume more deeply and further adjust noise cancellation), to enable the user to more fully hear themselves and the nearby voice, to permit the user and nearby person to have a smooth conversation. The wearable device may further determine when the conversation has ended (e.g., detect whether there is any more talking happening) using both self-voice and far-field voice detection, and may automatically return the audio level to the previous audio level (e.g., the audio volume and noise cancellation setting before the device ducked the audio level), as described above.

To help differentiate between the voice of one or more nearby people in a user’s environment (e.g., far-field voice) and the voice of the user (e.g., self-voice), multiple different sensors may be used. For instance, one or more environment-facing microphones may be used in combination with one or more microphones facing and/or acoustically coupled with the user’s ear canal(s) to help with the differentiation. Note that the one or more environment-facing microphones may also be used for active noise cancelling (ANC) purposes (generally known as feedforward microphones) and the one or more microphones facing and/or acoustically coupled with the user’s ear canal(s) may also be used for ANC purposes. At least one accelerometer, at least one gyroscope, and/or at least one inertial measurement unit (IMU) could alternatively or additionally be used with the microphone(s) to help with the differentiation.

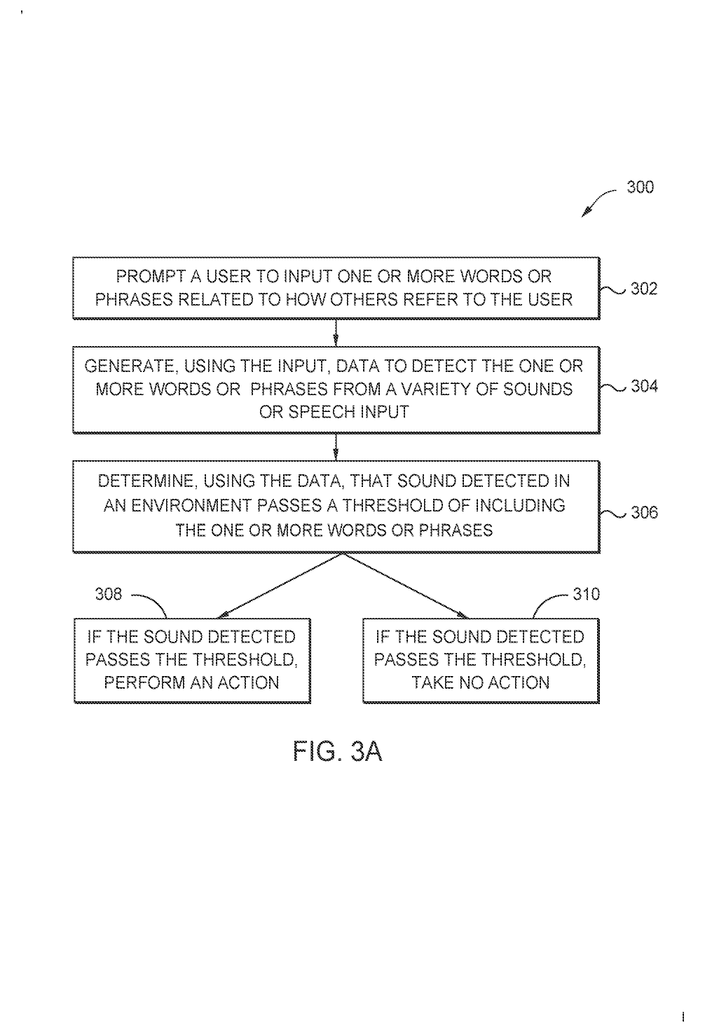

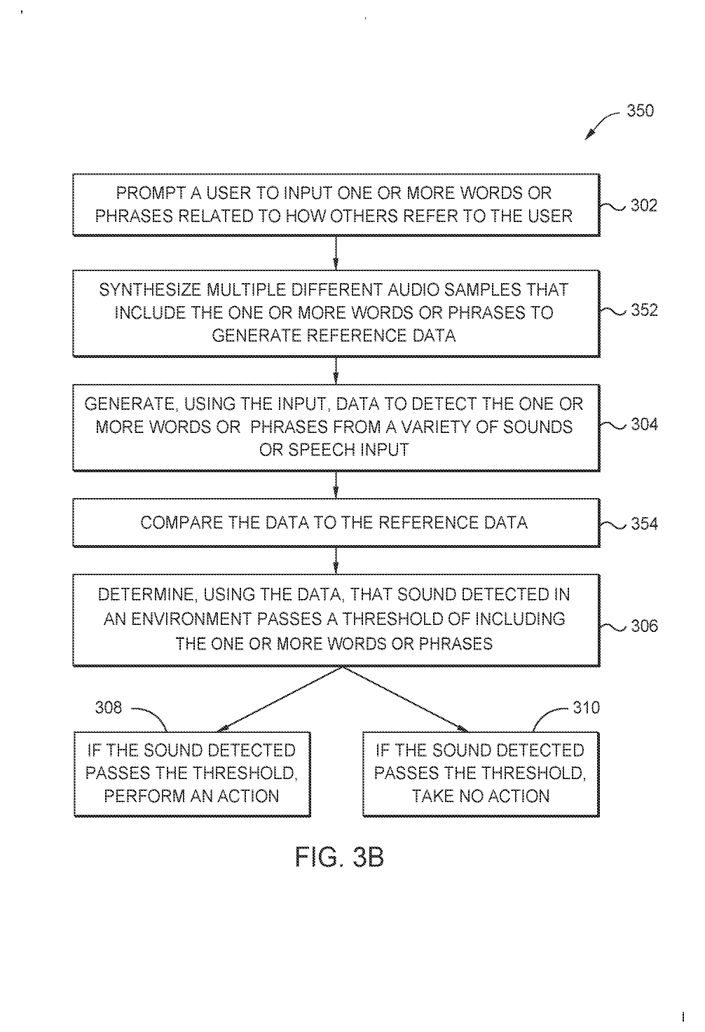

FIG. 3A illustrates example operations 300 performed by a system in communication with a wearable device (e.g., the wearable device 110 of FIGS. 1-2B) worn by a user for managing ambient noise, according to certain aspects of the present disclosure. In some embodiments, the wearable device performs the operations 300. FIG. 3B illustrates example operations 350 performed by a wearable device (e.g., the wearable device 110 of FIGS. 1-2B) worn by a user for managing ambient noise, according to certain aspects of the present disclosure. Aspects of the operations 300 and 350 may be used in combination with one another.

The operations 300 may generally include, at block 302, prompting a user to input one or more words or phrases related to how others refer to the user. In aspects, the one or more words or phrases are input as text into an interface of a computing device, such as the user input interface 216 of the computing device 120 of FIG. 2B. In other aspects, the one or more words or phrases are input as audio (i.e., spoken) into one or more microphones, such as the microphones 111, 112 of FIG. 1, of the wearable device. The one or more words or phrases are selected by the user, and may be any common term or phrase for how the user is most-often referred to by others or the user’s name preference. For example, the one or more words or phrases may be the user’s name, such as “Jeff” or “hey Jeff”, or a term of endearment, such as “babe”.

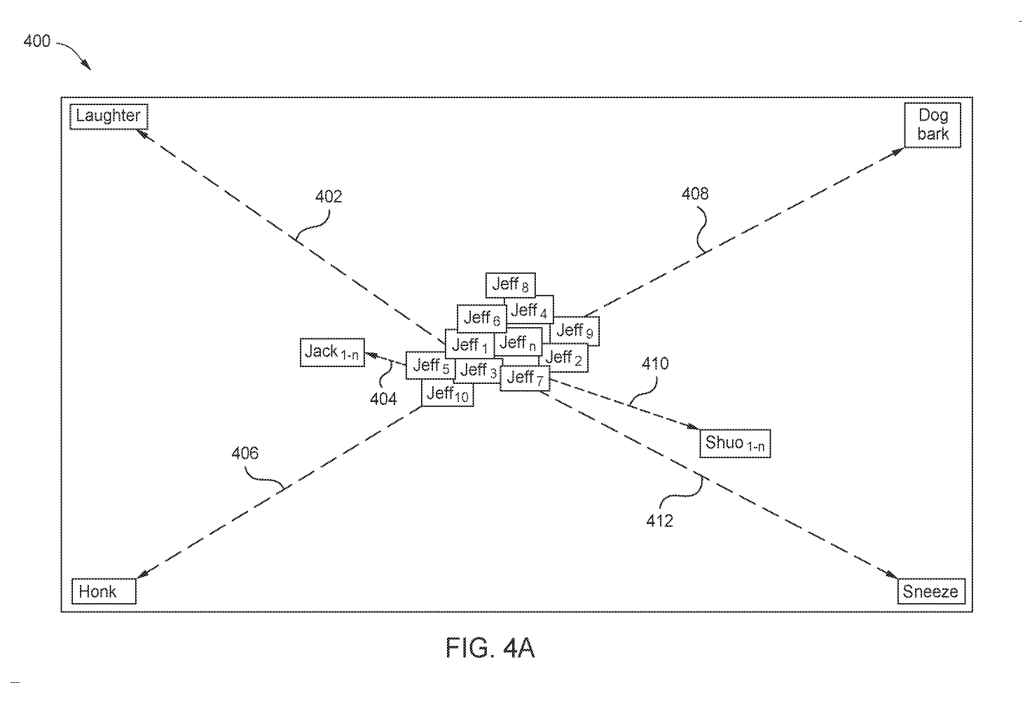

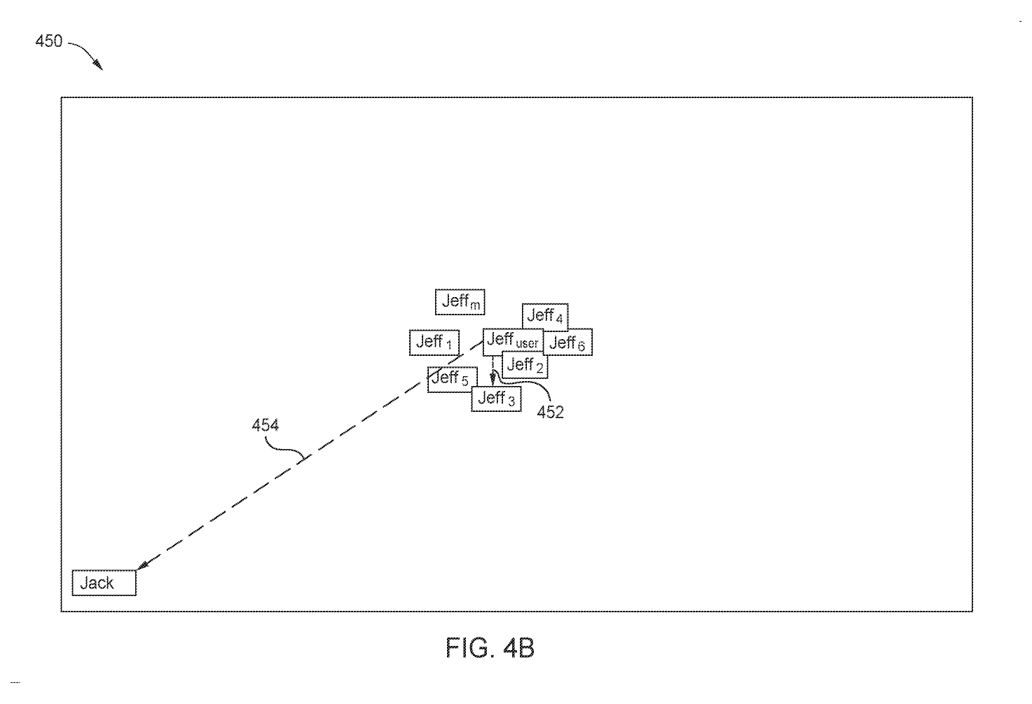

According to certain aspects, the operations 300 may further include, at block 304, generating, using the input, data to detect the one or more words or phrases from a variety of sounds of speech input. At least one processor of the wearable device, such as the processor 221 of FIG. 2A, is configured to generate the data. The data may include a plurality of ways to say the one or more words or phrases, such as about 10 to 20 different wants to say the one or more words or phrases. Generating the data is described further below in FIGS. 4A-4B, using reference data and negative reference data in a vector space, such as the vector space 450 of FIG. 4B. The reference data may be referred to herein as embeddings and/or audio samples.

According to certain aspects, the operations 300 may further include, at block 306, the at least one processor determining, using the data, that sound detected in an environment passes a threshold of including the one or more words or phrases. In aspects, the determination is performed using a “few-show learning approach”. In aspects, the threshold is a probability that the sound detected in the environment includes the one or more words or phrases. In other aspects, as described below in FIGS. 4A-4B, the threshold is a “distance” measurement between the reference data and the negative reference data in the vector space.

According to certain aspects, if the sound detected passes the threshold, the operations 300 may further include, at block 308, performing an action. In aspects, the action comprises pausing or decreasing a volume of listening content on the wearable device. The sound detected passing the threshold indicates that another person is saying the user’s one or more words or phrases. Aspects where the listening content is paused or decreased may relate to managing ambient noise, such as when another person wishes to converse or gain the user’s attention. Examples of management of ambient noise is described in co-pending patent application titled “Ambient Noise Management To Facilitate User Awareness And Interaction,” United States App. No. 18/356,976, filed July 21, 2023, assigned to the same assignee of this application, which is herein incorporated by reference. Upon performing the action), in certain embodiments, the operations 300 being again at block 302.

According to certain aspects, if the sound detected does not pass the threshold, the operations 300 may further include, at block 310, taking no action and continuing to output the listening content. The operations 300 may then begin again at block 302.

FIG. 3B illustrates example operations 350 performed by a wearable device (e.g., the wearable device 110 of FIGS. 1-2B) worn by a user for managing ambient noise, according to certain aspects of the present disclosure. As noted above, aspects of the operations 300 and 350 may be used in combination with one another.

The operations 350 may generally include, at block 302, prompting the user to input the one or more words or phrases related to how others refer to the user. At block 352, the at least one processor is configured to synthesize multiple different audio samples that include the one or more words or phrases to generate or create reference data. Synthesizing the multiple different audio samples may comprise utilizing models that can map from text to sound (e.g., map from “Hello Jeff”, to the audio of someone speaking “Hello Jeff”). A synthesizer may then be used to generate lots of audio samples, which can then be used to train an encoder network. The encoder network is then utilized to generate or create reference data and negative reference data in a vector space, such as the vector space 400 of FIG. 4A, and maps the synthesized audio samples to points in the vector space.

According to certain aspects, the operations 350 may further include, at block 304, the at least one processor is configured to generate, using the input, data to detect the one or more words or phrases from a variety of sounds of speech input. The data may include a plurality of ways to say the one or more words or phrases, such as about 10 to 20 different wants to say the one or more words or phrases.

According to certain aspects, the operations 350 may further include, at block 354, the at least one processor determining, comparing the data to the reference data. Comparing the data is described further below in FIGS. 4A-4B, using the reference data and negative reference data in a vector space, such as the vector space 450 of FIG. 4B.

According to certain aspects, the operations 350 may further include, at block 306, the at least one processor determining, using the data, that sound detected in an environment passes a threshold of including the one or more words or phrases. In aspects, the determination is performed using a “few-show learning approach”. In aspects, the threshold is a probability that the sound detected in the environment includes the one or more words or phrases. In other aspects, as described below in FIGS. 4A-4B, the threshold is a “distance” measurement between the reference data and the negative reference data in the vector space.

According to certain aspects, if the sound detected passes the threshold, the operations 350 may further include, at block 308, performing an action. In aspects, the action comprises pausing or decreasing a volume of listening content on the wearable device. The sound detected passing the threshold indicates that another person is saying the user’s one or more words or phrases. Aspects where the listening content is paused or decreased may relate to managing ambient noise, such as when another person wishes to converse or gain the user’s attention.

FIG. 4A illustrates an exemplary vector space 400 that is utilized during the operations 300 and/or the operations 350, according to certain aspects of the present disclosure. The vector space 400 may be generated or formed when an encoder model or network is trained, such as on a server. Once the encoder model learns the vector space 400, the vector space 400 can be run on the device 120 of FIG. 2B, where the computing device 120 of FIG. 2B is in communication with the wearable device 110 of FIGS. 1-2B. The exemplary vector space 400 may be generated using a deep-learning-based model, and may be a back-end process performed during manufacturing. In aspects, the exemplary vector space 400 is utilized at block 352 of operations 350. An encoder model can project audio samples into the associated points in the vector space 400. These points in the vector space 400 can then be used to create reference data

The vector space 400 is utilized to teach a system word or phrase recognition. Continuing with the example name “Jeff”, the vector space 400 creates a plurality of reference data points or embeddings (Jeff₁-Jeffₙ) for the word or phrase, either generated from text or audio. The plurality of reference data points Jeff₁-Jeffₙ may be numerical representations of audio samples representing specific words, phrases, and/or sounds in the vector space 400. The plurality of reference data points Jeff₁-Jeffₙ may be generated by having a plurality of people speak the word “Jeff” with different tones, accents, inflections, etc. The plurality of reference data points Jeff₁-Jeffₙ may be hundreds of reference data points (e.g., n is equal to or greater than 100) that have been pre-obtained for teaching purposes. As shown, the plurality of reference data points Jeff₁-Jeffₙ are all closely clustered together and/or overlapping, such that a distance between the various reference data points Jeff₁-Jeffₙ is miniscule or non-existent, indicating that each reference data point Jeff₁-Jeffₙ is the same word.

The non-Jeff reference data points may further include other names, such as Jack₁₋ₙ and Shuo₁₋ₙ (where 1-n indicates a plurality of the same word). The non-Jeff reference data may further utilize all background noises, such as laughter, dog barks, car honks, and sneezing.

The vector space 400 further utilizes negative reference data to provide context for various words to help teach the system. For example, the negative reference data points in the vector space 400 may include data points that are more abstract — where the semantic meaning of the reference data points is unknown. The system is then configured to determine a distance or probability of what a word or sound entered into the vector space 400 is.

As noted above, the plurality of reference data points Jeff₁-Jeffₙ are all closely clustered together and/or overlapping such that a distance between the various reference data points Jeff₁-Jeffₙ is none. Conversely, the system is able to determine that the word Jack₁₋ₙ is spaced from the Jeff₁-Jeffₙ reference data by a distance 404, and that the word Shuo₁₋ₙ is spaced from the Jeff₁-Jeffₙ reference data by a distance 410. As the word Jack is more similar to the word Jeff than it is to the word Shuo, the distance 404 is less than the distance 410. However, since the words Jeff and Jack are spaced by the distance 404, the system determines that Jeff and Jack are different words.

Similarly, the negative reference data laughter is spaced a distance 402 from Jeff, a car honk is spaced a distance 406 from Jeff, dog barks are spaced a distance 408 from Jeff, and a sneeze is spaced a distance 412 from Jeff. The distances 402, 406, 408, and 412 are significantly greater than the distances 404 and 410, indicating that the various noises are pronounced nothing like the word Jeff. By utilizing a plurality of names and sounds within a vector space 400, the system can be trained to easily identify various names with high precision.

FIG. 4B illustrates an exemplary vector space 450 that is utilized during the operations 300 and/or the operations 350, according to certain aspects of the present disclosure. The exemplary vector space 450 may be generated or formed the wearable device 110 of FIGS. 1-2B. The exemplary vector space 450 may be generated using a few-shot learning approach, and may be performed by the wearable device during real-time. In aspects, the exemplary vector space 450 is utilized at block 304 of operations 300 and 350 to generate the data to detect the one or more words of phrases input by the user. The exemplary vector space 450 may further be utilized at block 306 of operations 300 and 350 and/or block 354 of operations 350. The vector space 450 may be utilized or based off of the vector space 400 of FIG. 4A.

When the user inputs their one or more words or phrases, the system projects the one or more words or phrases into the vector space 450 by generating a data point for the user’s one or more words or phrases, Jeffᵤₛₑᵣ (i.e., the data generated at block 304 in operations 300 and 350), as well as a plurality of reference data points for the user’s one or more words or phrases, Jeff₁-Jeffₘ. The data Jeffᵤₛₑᵣ may be generated from audio or text. The plurality of reference data points Jeff₁-Jeffₘ may be tens of reference data points (e.g., m is equal to or greater than 10) representing audio samples. Comparatively, the vector space 450 utilizes fewer reference data points than the vector space 400 (i.e., n is greater than m).

When a person speaks near the user while the user is wearing the wearable device, the wearable device compares the word the person said in the vector space 450 to determine whether the person spoke the user’s one or more words or phrases by determining a distance between the user’s one or more words or phrases and the person’s spoken word. For example, if the person said another name, Jack, the wearable device is configured to compare the words Jack and Jeff, and determine that Jack is spaced a distance 454 from Jeff. Thus, the wearable device is able to determine that the person did not speak the user’s name. In some aspects, the wearable device is configured to save the reference data point of Jack as a negative reference data point for comparison purposes. Upon determining the word the person spoke is not the user’s name, the wearable device takes not action and continues to play the user’s listening content (i.e., block 310 in operations 300 and 350).

Similarly, when a person speaks the user’s name, the wearable device is configured to measure a distance in the vector space 450 to make a positive determination. In aspects where a user speaks their one or more words or phrases to input them, a person may say the user’s name slightly differently than the user (i.e., Jeff₃). The wearable device may be configured to measure the distance 452 between Jeffᵤₛₑᵣ and Jeff₃, and determine that the distance 452 is negligible, as the distance 452 is much closer than the distance 454. Upon determining the word the person spoke is the user’s name, the wearable device may pause or decrease the user’s listening content to ensure the person has the user’s attention, like described above in block 308 of operations 300 and 350.

The wearable device is configured to utilize the vector space 450 in real-time, and is capable of making the determination very quickly, such as in less one second, as the vector space 450 utilizes only a few reference data points as compared to the vector space 400. Furthermore, the vector spaces 400 and 450 are not cloud-based, and thus, are more accurate and cause less privacy concerns.

It is noted that the processing related to ambient noise management as discussed in aspects of the present disclosure may be performed natively in the wearable device, by the computing device, or a combination thereof.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. A method, comprising:
prompting a user to input one or more words or phrases related to how others refer to the user;
generating, using the input, data to detect the one or more words or phrases from a variety of sounds of speech input; and
determining, using the data, that sound detected in an environment passes a threshold of including the one or more words or phrases.

2. The method of claim 1, further comprising comparing the data to reference data.

3. The method of claim 2, wherein the reference data comprises a plurality of reference audio samples that include the one or more words or phrases.

4. The method of claim 3, wherein the reference data is pre-obtained by a plurality of non-users.

5. The method of claim 2, wherein the reference data comprises negative data that fails to include the one or more words or phrases.

6. The method of claim 5, wherein the data is plotted against the reference data in a vector space to determine how closely the data matches the reference data versus the negative data.

7. The method of claim 6, wherein the threshold is a distance measured within the vector space that the sound detected in the environment includes the one or more words or phrases based on the plotted data.

8. The method of claim 1, further comprising performing an action in response to the determination that the sound detected passes the threshold.

9. The method of claim 1, wherein the input is text.

10. The method of claim 1, wherein the input is audio.

11. The method of claim 10, further comprising synthesizing multiple different audio samples that include the one or more words or phrases prior to generating the data.

12. A system, comprising:
a device comprising:
an interface; and
at least one first processor configured to prompt a user to input one or more words or phrases related to how others refer to the user into the interface; and
a wearable audio device in communication with the device, the wearable audio device comprising:
at least one audio sensor; and
at least one second processor configured to:
generate, using the input, data to detect the one or more words or phrases from a variety of sounds of speech input; and
determine, using the data, that sound detected in an environment passes a threshold of including the one or more words or phrases.

13. The system of claim 12, wherein the at least one first processor is further configured to synthesize multiple different audio samples that include the one or more words or phrases prior to the data being generated by the at least one second processor.

14. The system of claim 12, wherein the at least one second processor is further configured to compare the data to reference data.

15. The system of claim 14, wherein the reference data comprises a plurality of reference audio samples that include the one or more words or phrases.

16. The system of claim 15, wherein the reference data is pre-obtained by a plurality of non-users.

17. The system of claim 14, wherein the reference data comprises negative data that fails to include the one or more words or phrases.

18. The system of claim 17, wherein the data is plotted against the reference data in a vector space to determine how closely the data matches the reference data versus the negative data.

19. The system of claim 18, wherein the threshold is a distance measured within the vector space that the sound detected in the environment includes the one or more words or phrases based on the plotted data.

20. The system of claim 12, wherein the at least one second processor is further configured to perform an action in response to the determination that the sound detected passes the threshold.

21. The system of claim 12, wherein the input is text or audio.
